(19) United States
(12) Patent Application Publication
(10) Pub. No.: US 2014/0316647 A1
(43) Pub. Date: Oct. 23, 2014

(54) ACTIVE CONTROL METHOD OF ACCELERATOR PEDAL EFFORT

(71) Applicants: Kia Motors Corporation, Seoul (KR); Hyundai Motor Company, Seoul (KR)

(72) Inventors: Jeong Seon MIN, Gwangju (KR); Yang Rae CHO, Suwon-si (KR)

(21) Appl. No.: 13/941,222

(22) Filed: Jul. 12, 2013

(30) Foreign Application Priority Data
Apr. 23, 2013 (KR) 10-2013-0044848

(51) Int. Cl. G05G 1/40

(52) U.S. Cl. CPC G05G 1/40
USPC 701/36

(57) ABSTRACT

An active control method of accelerator pedal effort identifies a driver's habit of manipulation when a driver starts a vehicle having a pedal effort controllable accelerator pedal from a stationary state. Thus, the active control method can actively vary the accelerator pedal effort according to accelerator pedal manipulation habits of the driver, thereby improving the accelerator pedal manipulation efficiency of the driver.

### CROSS REFERENCE TO RELATED APPLICATION

This application claims under 35 U.S.C. §119(a) priority to and the benefit of Korean Patent Application No. 10-2013-0044848, filed on Apr. 23, 2013, the entire contents of which are incorporated herein by reference.

### TECHNICAL FIELD

The present disclosure relates, in general, to an active control method of accelerator pedal effort and, more particularly, to an active control method of accelerator pedal effort which is configured such that, when a vehicle starts (a case in which a vehicle speed increases from 0 (zero) to a speed higher than zero), the active control method can actively vary the accelerator pedal effort according to accelerator pedal manipulation habits of a driver, thereby improving the accelerator pedal manipulation efficiency of the driver.

### BACKGROUND

FIG. 1 illustrates an organ type accelerator pedal of related art including: a pedal arm housing 1 securely mounted on a frame panel that is placed below a driver's seat; a pedal arm 2 with one end rotatably connected to the pedal arm housing 1; a pedal bracket 3 securely mounted on a floor panel placed below the driver's seat; and a pedal pad 4 with one end rotatably connected to the pedal bracket 3 and coupled to the pedal arm 2 by ball joint coupling.

A spring plate 5 is combined with an end of the pedal arm 2 placed in the pedal arm housing 1. Here, a spring 6 is installed in the pedal arm housing 1 in such a way that a first end of the spring 6 is held by the spring plate 5, and a second end of the spring 6 is held by the pedal arm housing 1.

According to the related art, when the pedal arm 2 is rotated around a hinge shaft 7, the spring 6 is elastically compressed and forms pedal effort of the pedal pad 4.

However, the related art uses a spring having predetermined elastic modulus so as to meet the safety laws and regulations, thereby pedal effort of the related art cannot be changed unless the spring 6 is replaced by another one. Further, it is impossible to actively vary accelerator pedal effort according to the accelerator pedal manipulation habits of a driver when a vehicle is started, thereby providing discomfort to the driver when manipulating the accelerator pedal.

The foregoing is intended merely to aid in the understanding of the background of the present disclosure, and is not intended to mean that the present disclosure falls within the purview of the related art that is already known to those skilled in the art.

### SUMMARY

The present disclosure has been made keeping in mind the above problems occurring in the related art, and is intended to propose an active control method of accelerator pedal effort configured such that, when a driver starts a vehicle having controllable accelerator pedal effort, the active control method can vary the accelerator pedal effort according to accelerator pedal manipulation habits of the driver, thereby improving the accelerator pedal manipulation efficiency of the driver.

According to an aspect of the present invention, an active control method of accelerator pedal effort is provided. The method includes a data storing step of storing information data about accelerator pedal manipulation habits of a driver when the driver starts a vehicle having a controllable pedal effort accelerator pedal from a stationary state, a manipulation habit change determination step of determining whether a present accelerator pedal manipulation habit of the driver when starting the vehicle has changed from a previous accelerator pedal manipulation habit by comparing the present accelerator pedal manipulation habit to the previous accelerator pedal manipulation habit based on the stored information data, and a pedal effort control step of determining a present accelerator pedal effort control value based on results of the manipulation habit change determination step and controlling a present accelerator pedal effort using the determined present accelerator pedal effort control value.

The manipulation habit change determination step may be performed based on an operational percent of an Accelerator Position Sensor (APS) per unit time or a period of time by which a vehicle speed reaches a predetermined speed.

If there is no change between the present accelerator pedal manipulation habit and the previous accelerator pedal manipulation habit determined at the manipulation habit change determination step, the present accelerator pedal effort at the pedal effort control step may be controlled to be maintained at most recent previous pedal effort.

If the present accelerator pedal manipulation habit has become more vigorous than the previous accelerator pedal manipulation habit determined at the manipulation habit change determination step, the present accelerator pedal effort at the pedal effort control step may be controlled to be reduced to a preset target pedal effort.

Further, if the present accelerator pedal manipulation habit has been attenuated than the previous accelerator pedal manipulation habit, the present accelerator pedal effort at the pedal effort control step may be increased to a preset target pedal effort.

The active control method may further include: a pedal effort control system checking step of determining whether a pedal effort control system is in a normal state when the vehicle is started, prior to the data storing step.

Here, only when the pedal effort control system is in the normal state determined at the pedal effort control system checking step, the data storing step may be performed, and when the pedal effort control system is determined to be in an abnormal state, the present accelerator pedal effort may be reset to an initial pedal effort.

Further, when a battery voltage signal represents a normal state of a battery and no signal requiring an initialization of the present accelerator pedal effort against an abnormal state is output, and also when a signal representing a pedal effort active control mode is generated, it is determined at the pedal effort control system checking step that the pedal effort control system is in the normal state.

As described above, the active control method of accelerator pedal effort according to the present disclosure is advantageous when a driver starts a vehicle having the controllable accelerator pedal effort. The active control method can actively vary the accelerator pedal effort according to accelerator pedal manipulation habits of the driver, thereby improving the accelerator pedal manipulation efficiency of the driver.

### BRIEF DESCRIPTION OF THE DRAWINGS

The above and other objects, features and other advantages of the present disclosure will be more clearly understood from the following detailed description when taken in conjunction with the accompanying drawings.

FIG. 1 is a view illustrating accelerator pedal of the related art without a pedal effort control function.

FIGS. 2 through 5 are views illustrating an accelerator pedal having a pedal effort control function according to the present disclosure.

FIG. 6 is a flowchart illustrating a method of actively controlling the pedal effort of the accelerator pedal having the pedal effort control function according to the present disclosure.

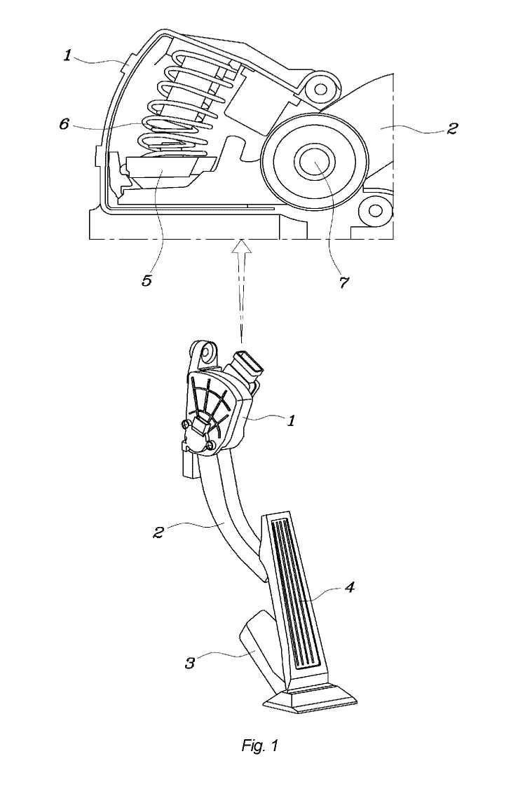

### DETAILED DESCRIPTION

Hereinbelow, an embodiment of the present invention will be described in detail with reference to the accompanying drawings.

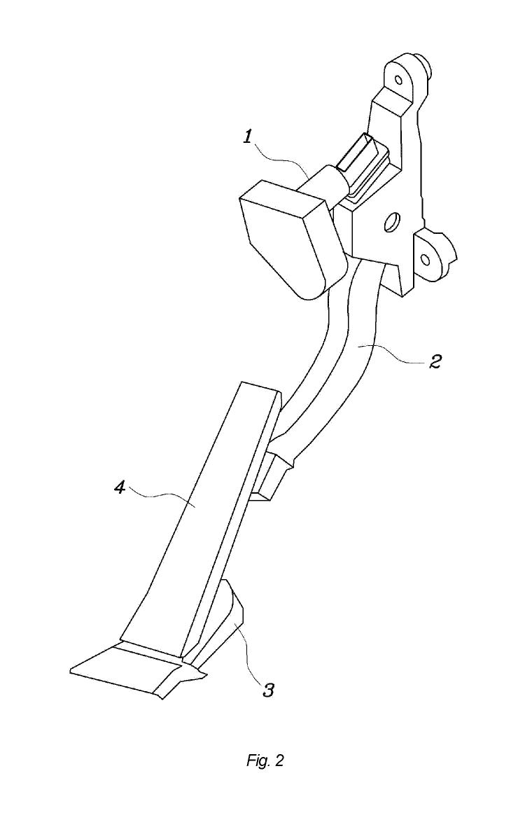

Referring to FIGS. 2 through 5, a vehicle accelerator pedal having a pedal effort control function includes: a pedal arm housing 1 securely mounted on a frame panel placed below a driver's seat; a pedal arm 2 with one end rotatably connected to the pedal arm housing 1; a pedal bracket 3 securely mounted on a floor panel placed below the driver's seat; and a pedal pad 4 with one end rotatably connected to the pedal bracket 3 and coupled to the pedal arm 2 by ball joint coupling.

A spring plate 5 is mounted on an end of the pedal arm 2 that is placed in the pedal arm housing 1. The pedal arm 2 is installed to be rotated around a hinge shaft 7.

The accelerator pedal having a pedal effort control function further includes a pedal effort control module 10, wherein the pedal effort control module 10 includes: a spring 11 with a first end held by an end of the pedal arm 2 that is placed in the pedal arm housing 1; a spring support block 12 installed so as to support a second end of the spring 11; a motor 13 securely installed in the pedal arm housing 1; and a power transmitter 14 transmitting output power of the motor 13 to the spring support block 12, thereby moving the spring support block 12 so as to vary the length of the spring 11.

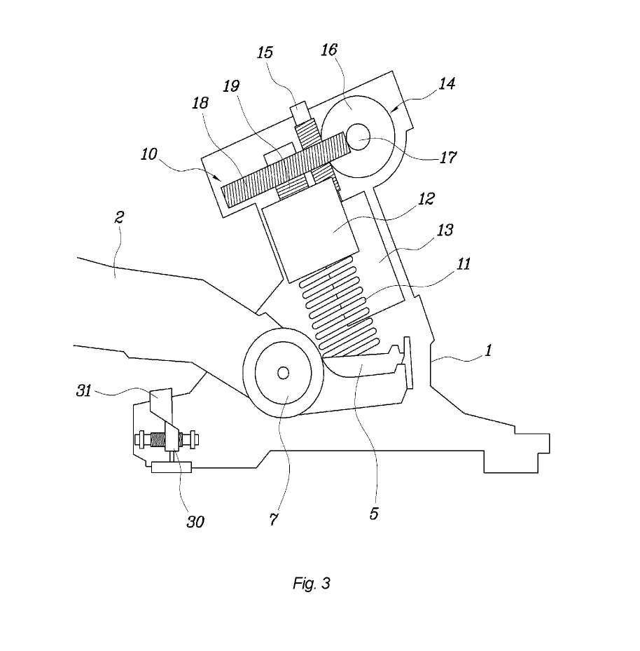

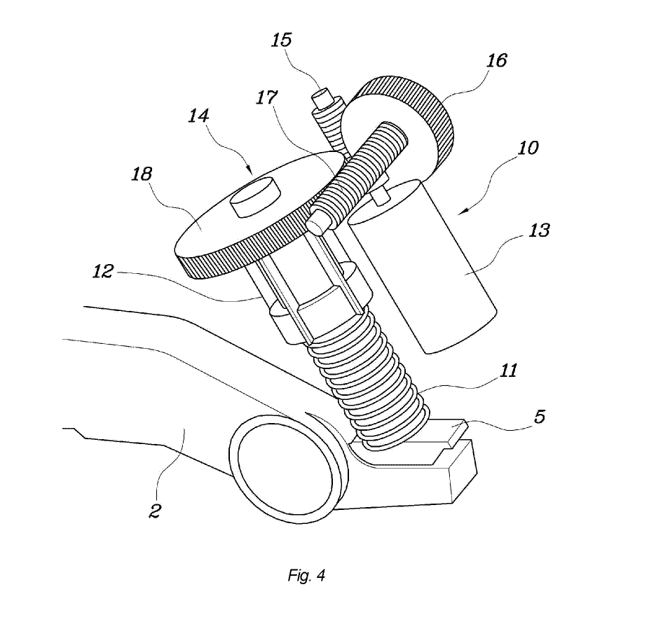

Here, the spring 11 may be directly held on the end of the pedal arm 2. Referring to FIGS. 3 and 4 in an embodiment of the disclosure, the spring plate 5 is coupled to the end of the pedal arm 2 in the pedal arm housing 1, and the lower end of the spring 11 is held on the spring plate 5.

When the pedal arm 2 is rotated around the central axis of the hinge shaft 7, the spring 11 is elastically compressed between the spring plate 5 and the spring support block 12. The elastic compression of the spring 11 is transmitted to the pedal pad 4 through the pedal arm 2 and forms pedal effort in the pedal pad 4.

The motor 13 is connected to the spring support block 12 by the power transmitter 14 to transmit the output power. The power transmitter 14 includes: a first worm gear integrated with an output shaft of the motor 13; a first worm wheel gear 16 rotatably engaged with the first worm gear 15; a second worm gear 17 integrated with the center of the first worm wheel gear 16; a second worm wheel gear 18 rotatably engaged with the second worm gear 17; and a gear bolt 19 integrally disposed at the center of the second worm wheel gear 18 such that the gear bolt 19 protrudes from the center of the second worm wheel gear 16, with threads formed around the outer circumferential surface of the gear bolt 19.

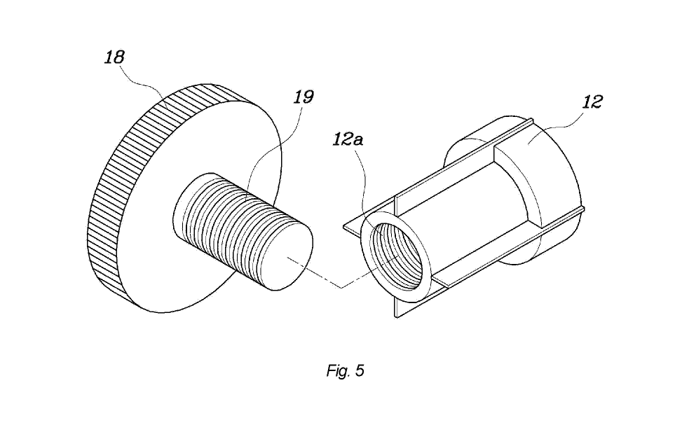

Referring to FIG. 5, the spring support block 12 has a locking hole 12a with threads formed around the inner circumferential surface of the locking hole 12a engaging with the gear bolt 19. As the second worm wheel gear 18 rotates, the spring support block 12 rectilinearly moves along the gear bolt 19, and the length of the spring 11 can be changed, thereby varying pedal effort.

The motor 13 can be automatically controlled by a controller (not shown) taking into consideration vehicle running conditions, driver's physical conditions, driving habits of a driver, a selected gear shift stage, etc.

When pedal effort is controlled by the pedal effort control module 10 installed in a vehicle, and the vehicle starts from a stationary state (a case in which speed increases from 0 (zero) to a speed higher than zero), accelerator pedal effort can be actively varied according to accelerator pedal manipulation habits of the driver, thereby improving the accelerator pedal manipulation efficiency.

For example, when the vehicle starts by a driver having a habit of quickly manipulating the accelerator pedal, the pedal effort control module 10 reduces pedal effort of the accelerator pedal allowing the vehicle to start quickly, thereby improving the accelerator pedal manipulation efficiency of the driver. On the contrary, when a driver having a habit of slowly manipulating the accelerator pedal starts the vehicle, the pedal effort control module 10 increases pedal effort, thereby preventing quick starting of the vehicle.

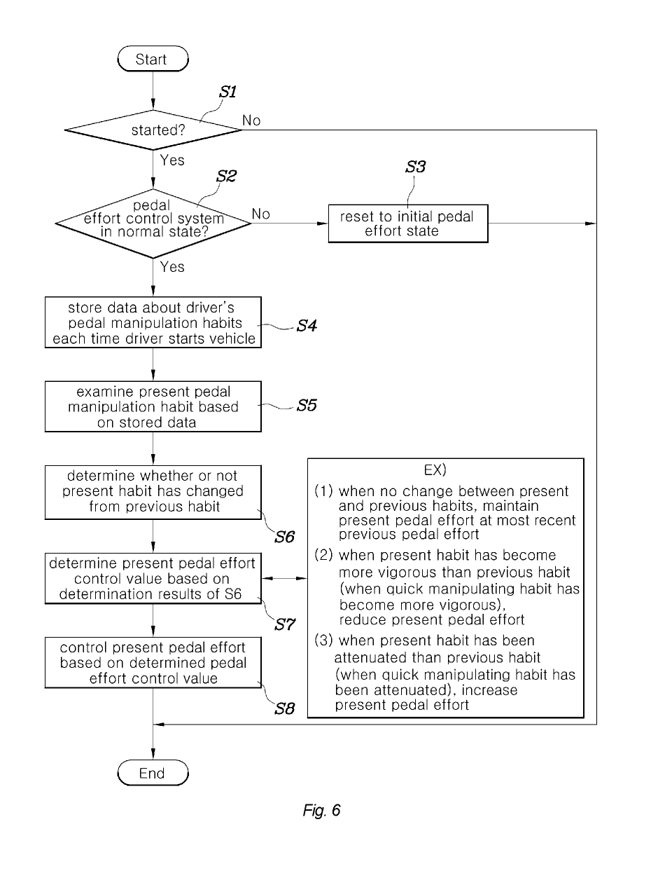

Referring to FIG. 6, the active control method of accelerator pedal effort according to an embodiment of the disclosure comprises: a pedal effort control system checking step of determining whether a pedal effort control system is in a normal state when a vehicle having the controllable pedal effort accelerator pedal is started; a data storing step of storing information data about the accelerator pedal manipulation habits of a driver when the driver starts the vehicle from a stationary state; a manipulation habit change determination step of determining whether the driver's accelerator pedal manipulation habit has changed or not by comparing the present accelerator pedal manipulation habit to the previous accelerator pedal manipulation habit; and a pedal effort control step of determining a present accelerator pedal effort control value based on results of the manipulation habit change determination step and controlling present accelerator pedal effort using the determined pedal effort control value.

Here, only if the pedal effort control system is determined to be in the normal state at the pedal effort control system checking step, the data storing step is performed. When a battery voltage signal represents a normal state of a battery and no signal for an initialization of the present accelerator pedal effort against an abnormal state is output, and also when a signal representing a pedal effort active control mode is generated, the pedal effort control system is determined to be in the normal state.

Further, when the pedal effort control system is determined to be in an abnormal state at the pedal effort control system checking step, the present accelerator pedal effort is reset to an initial pedal effort.

Here, the initial pedal effort state means a reset state of the pedal effort.

Further, the manipulation habit change determination step is performed based on an operational percent of an accelerator position sensor (APS) per unit time or a period of time by which vehicle speed reaches a predetermined speed. However, it should be understood that the manipulation habit change determination step may be performed based on another value without being limited.

In an embodiment of the present invention, when there is no change between the present and the previous accelerator pedal manipulation habit determined at the manipulation habit change determination step that, the present accelerator pedal effort at the pedal effort control step is maintained at the most recent previous pedal effort.

When the present accelerator pedal manipulation habit has become more vigorous than the previous accelerator pedal manipulation habit (the driver's habit of quickly manipulating the accelerator pedal when the driver starts the vehicle has become more vigorous, or the driver's desire for a quick start of the vehicle has increased) determined at the manipulation habit change determination step that, the present accelerator pedal effort at the pedal effort control step is reduced to a preset target pedal effort.

Further, when the present accelerator pedal manipulation habit has been attenuated than the previous accelerator pedal manipulation habit (the driver's habit of quickly manipulating the accelerator pedal has been attenuated or the driver's desire for a quick start of the vehicle has been attenuated) determined at the manipulation habit change determination step, the present accelerator pedal effort at the pedal effort control step is increased to the preset target pedal effort.

Hereinbelow, the operation of the embodiment of the present invention will be described. First, the operation of controlling the pedal effort will be described.

Referring to FIG.3, when the motor 13 is operated by the controller, and output power of the motor 13 is transmitted to the spring support block 12 through the worm gears 15 and 17, the worm wheel gears 16 and 18, and the gear bolt 19, the spring support block 12 moves upward or downward along the gear bolt 19.

When the spring support block 12 moves upward along the gear bolt 19 (being away from the spring plate), the spring 11 is elastically tensioned by restoring force increasing the length of the spring 11. Here, the spring force acting on the pedal arm 2 is reduced, and so is the accelerator pedal effort.

On the contrary, when the spring support block 12 moves downward along the gear bolt 19 (in a direction close to the spring plate), the spring 11 is elastically compressed, and the length of the spring 11 is reduced. Here, the spring force acting on the pedal arm 2 is increased, and so is the accelerator pedal effort.

In an embodiment, the motor 13 is automatically operated under the control of the controller (not shown). For example, in a process of starting a vehicle from a stationary state, if the accelerator pedal manipulation habit of a driver has changed to a habit of quickly starting the vehicle, the motor automatically controls the accelerator pedal effort so as to reduce the accelerator pedal effort. On the other hand, in the process of starting the vehicle from a stationary state, when the accelerator pedal manipulation habit of the driver has changed to a habit of starting the vehicle slowly, the motor automatically controls the accelerator pedal effort so as to increase the accelerator pedal effort.

When driver drives the vehicle at low speed, for example, due to traffic congestion, the pedal effort can be reduced, thereby reducing fatigue of the driver caused by repeated pedal manipulation. However, when the vehicle is driven at high speed, for example, on an express highway, the pedal effort can be increased, thereby supporting the pedal under a constant pressure and reducing fatigue in a driver's ankle.

Further, for uphill driving, the pedal effort is controlled to be reduced so as to increase a pedal manipulation amount, and for downhill driving, the pedal effort is controlled to be increased so as to reduce the pedal manipulation amount.

In addition, when the vehicle runs at high speed or is driven in a safety mode, the pedal effort can be increased so as to allow a driver to drive the vehicle safely. Further, the pedal effort can be appropriately controlled in consideration of age, sex and physical conditions of the driver.

Hereinbelow, with reference to FIG. 6, the method of actively varying the accelerator pedal effort according to the accelerator pedal manipulation habit of a driver when the driver starts a vehicle having the controllable pedal effort accelerator pedal will be described in detail.

When the vehicle is started (step S1), the controller determines whether the pedal effort control system is in a normal state or not (step S2). Here, when a battery voltage signal represents a normal state and no signal requiring an initialization of the present accelerator pedal effort against an abnormal state is output, and also when a signal representing a pedal effort active control mode is generated, the controller determines at step S2 that the pedal effort control system is in the normal state.

The controller determines whether the pedal effort control system is in the normal state at step S2 only when the battery voltage signal is 9V to 16.5V.

The present accelerator pedal effort is reset to an initial pedal effort state (step S3) when the controller determines that the pedal effort control system is in an abnormal state.

Information data about the accelerator pedal manipulation habits of the driver each time the driver starts the vehicle after stopping the vehicle is stored in a data storage (step S4) after the pedal effort control system is determined to be in the normal state. Thereafter, a present accelerator pedal manipulation habit of the driver when starting the vehicle is examined based on the stored information data (step S5). The control unit determines whether the present accelerator pedal manipulation habit of the driver when starting the vehicle has changed from a previous accelerator pedal manipulation habit of the driver or not (step S6)

The step of determining whether the present accelerator pedal manipulation habit of the driver has changed from the previous accelerator pedal manipulation habit of the driver is performed based on the operational percent of an APS per unit time or a period of time by which the vehicle speed reaches a predetermined speed.

Based on the determination results of step S6, the control unit determines the present accelerator pedal effort control value used in the process of starting the vehicle (step S7). The control unit controls the operation of the motor 13 based on the determined pedal effort control value, thereby controlling the present accelerator pedal effort (step S8)

Here, the process of controlling the accelerator pedal effort when starting the vehicle will be performed by three types of processes, as follows. First, if the present accelerator pedal manipulation habit has not changed from the previous accelerator pedal manipulation habit, the present accelerator pedal effort is maintained at the most recent pedal effort. In this case, the driver can stably manipulate the accelerator pedal.

Second, if the present accelerator pedal manipulation habit has become more vigorous than the previous accelerator pedal manipulation habit, the present accelerator pedal effort, when starting the vehicle, is reduced to a preset target pedal effort. In this case, the driver can quickly start the vehicle by easily manipulating the accelerator pedal.

Finally, if the present accelerator pedal manipulation habit has been attenuated than the previous accelerator pedal manipulation habit, the present accelerator pedal effort is increased to the preset target pedal effort. In this case, the present invention can prevent a quick start of the vehicle by the accelerator pedal, thereby improving safety.

When the control method of the present disclosure is to actively vary the accelerator pedal effort of the vehicle according to the accelerator pedal manipulation habits of the driver, the driver can easily manipulate the accelerator pedal and can efficiently prevent an undesired quick start of the vehicle.

As described above, the active control method of acceleration pedal effort according to the present disclosure is advantageous since the length of the spring 11 can be controlled by moving the spring support block 12 in response to an operation of the motor 13 without changing parts of an accelerator pedal with new parts easily varying the pedal effort as desired, and can efficiently meet safety law and regulations of the accelerator pedal effort regardless of the type of vehicle.

Further, the accelerator pedal effort can be actively controlled according to the accelerator pedal manipulation habits of a driver when starting the vehicle, and so the driver can easily and efficiently manipulate the accelerator pedal.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An active control method of accelerator pedal effort, comprising:
a data storing step of storing information data about accelerator pedal manipulation habits of a driver when the driver starts a vehicle having a pedal effort controllable accelerator pedal from a stationary state;
a manipulation habit change determination step of determining whether a present accelerator pedal manipulation habit of the driver for starting the vehicle has changed from a previous accelerator pedal manipulation habit by comparing the present accelerator pedal manipulation habit to the previous accelerator pedal manipulation habit based on the stored information data; and
a pedal effort control step of determining a present accelerator pedal effort control value based on results of the manipulation habit change determination step, and controlling a present accelerator pedal effort using the determined present accelerator pedal effort control value.

2. The active control method of accelerator pedal effort as set forth in claim 1, wherein the manipulation habit change determination step is performed based on an operational percent of an accelerator position sensor (APS) per unit time or a period of time by which a vehicle speed reaches a predetermined speed.

3. The active control method of accelerator pedal effort as set forth in claim 1, wherein, when there is no change between the present accelerator pedal manipulation habit and the previous accelerator pedal manipulation habit determined at the manipulation habit change determination step, the present accelerator pedal effort at the pedal effort control step is controlled to be maintained at a most recent previous pedal effort.

4. The active control method of accelerator pedal effort as set forth in claim 1, wherein, when the present accelerator pedal manipulation habit has become more vigorous than the previous accelerator pedal manipulation habit determined at the manipulation habit change determination step, the present accelerator pedal effort at the pedal effort control step is controlled to be reduced to a preset target pedal effort.

5. The active control method of accelerator pedal effort as set forth in claim 1, wherein, when the present accelerator pedal manipulation habit has been attenuated than the previous accelerator pedal manipulation habit determined at the manipulation habit change determination step, the present accelerator pedal effort at the pedal effort control step is controlled to be increased to a preset target pedal effort.

6. The active control method of accelerator pedal effort as set forth in claim 1, further comprising:
a pedal effort control system checking step of determining whether a pedal effort control system is in a normal state when the vehicle is started, prior to the data storing step.

7. The active control method of accelerator pedal effort as set forth in claim 6, wherein, only when the pedal effort control system is in the normal state determined at the pedal effort control system checking step, the data storing step is performed, and when the pedal effort control system is determined to be in an abnormal state, the present accelerator pedal effort is reset to an initial pedal effort.

8. The active control method of accelerator pedal effort as set forth in claim 6, wherein, when a battery voltage signal represents a normal state of a battery and no signal requiring an initialization of the present accelerator pedal effort against an abnormal state is output, and also when a signal representing a pedal effort active control mode is generated, it is determined at the pedal effort control system checking step that the pedal effort control system is in the normal state.
